(19) United States
(12) Patent Application Publication
(10) Pub. No.: US 2019/0094526 A1
(43) Pub. Date: Mar. 28, 2019

(54) ROTARY DRIVE APPARATUS

(71) Applicant: Nidec Corporation, Kyoto (JP)

(72) Inventors: Yoichi SEKII, Kyoto (JP); Junya MIZUKAMI, Kyoto (JP)

(21) Appl. No.: 16/104,223

(22) Filed: Aug. 17, 2018

(30) Foreign Application Priority Data
Sep. 28, 2017 (JP) 2017-188559
Dec. 26, 2017 (JP) 2017-248887

(51) Int. Cl. G02B 26/08; H02K 7/02

(52) U.S. Cl. CPC G02B 26/0816; H02K 7/02

(57) ABSTRACT

A rotary drive apparatus rotates a flywheel that holds a mirror and a lens, and includes a motor and the flywheel. The flywheel is rotatable about a central axis extending in a vertical direction through the motor. The flywheel includes an accommodating portion in which the lens is located. The lens includes a base portion including a light-transmitting portion that allows reflected light to pass therethrough, a first contact portion contactable with the accommodating portion on one of upstream and downstream sides of the base portion with respect to the direction of travel of the reflected light, and a second contact portion contactable with the accommodating portion on another one of the upstream and downstream sides of the base portion with respect to the direction of travel of the reflected light. At least one of the first and second contact portions is a projection that projects from the base portion.

### CROSS REFERENCE TO RELATED APPLICATIONS

This application claims the benefit of priority to Japanese Patent Application No. 2017-188559 filed on Sep. 28, 2017 and Japanese Patent Application No. 2017-248887 filed on Dec. 26, 2017. The entire contents of these applications are hereby incorporated herein by reference.

### BACKGROUND OF THE INVENTION

### 1. Field of the Invention

The present invention relates to a rotary drive apparatus.

### 2. Description of the Related Art

A known scanner apparatus used for position recognition in a head-mounted display (HMD) or the like typically has installed therein optical components, such as, for example, a mirror arranged to reflect incoming light coming from a light source, and a lens arranged to allow reflected light to pass therethrough. A known apparatus including an optical component, such as, for example, a lens, is described in, for example, JP-A 2009-283021. However, in a known optical apparatus described in JP-A 2009-283021, the lens is arranged to be in contact with one surface of a base (i.e., a holder) arranged to hold the lens, but is not in contact with the base at a region opposite to that surface. Therefore, after the lens is installed on the base, the lens may easily move before the lens is fixed to the base through an adhesive. That is, the known optical apparatus has a problem in that the accuracy with which the lens is temporarily fixed before the lens is fixed to the base through the adhesive may be insufficient.

### SUMMARY OF THE INVENTION

In view of the above circumstances, preferred embodiments of the present invention provide rotary drive apparatuses that achieve an improvement in the accuracy with which a lens is temporarily fixed before the lens is fixed through an adhesive.

A rotary drive apparatus according to a preferred embodiment of the present invention rotates a flywheel holding a mirror that reflects incoming light coming from a light source, and a lens that allows reflected light obtained by reflection of the incoming light to pass therethrough. The rotary drive apparatus includes a motor and the flywheel, the flywheel being supported by the motor to rotate about a central axis extending in a vertical direction. The flywheel includes an accommodating portion in which the lens is located. The lens includes a base portion including a light-transmitting portion that allows the reflected light to pass therethrough, a first contact portion contactable with the accommodating portion on one of an upstream side and a downstream side of the base portion with respect to a direction of travel of the reflected light, and a second contact portion contactable with the accommodating portion on another one of the upstream side and the downstream side of the base portion with respect to the direction of travel of the reflected light. At least one of the first contact portion and the second contact portion is a projection projecting from the base portion.

In the rotary drive apparatus according to the above preferred embodiment of the present invention, the base portion of the lens is supported by and in direct contact with the accommodating portion on one of the upstream side and the downstream side of the base portion with respect to the direction of travel of the reflected light, while the base portion is in contact with the accommodating portion through the projection on the other one of the upstream side and the downstream side of the base portion with respect to the direction of travel of the reflected light. That is, the lens is held while in contact with the accommodating portion at regions opposite to the lens on both the upstream and downstream sides of the lens with respect to the direction of travel of the reflected light. This leads to an improvement in the accuracy with which the lens is temporarily fixed before the lens is fixed through the adhesive.

The above and other elements, features, steps, characteristics and advantages of the present invention will become more apparent from the following detailed description of the preferred embodiments with reference to the attached drawings.

### BRIEF DESCRIPTION OF THE DRAWINGS

FIG. 1 is a perspective view of a light source, a frame, and a rotary drive apparatus according to a preferred embodiment of the present invention.

FIG. 2 is a vertical sectional view of a rotary drive apparatus according to a preferred embodiment of the present invention.

FIG. 3 is a perspective view of a flywheel according to a preferred embodiment of the present invention.

FIG. 4 is a perspective view illustrating an accommodating portion for a lens according to a preferred embodiment of the present invention.

FIG. 5 is a top view illustrating an accommodating portion for a lens according to a preferred embodiment of the present invention.

FIG. 6 is a perspective view of a lens according to a preferred embodiment of the present invention as viewed from outside the rotary drive apparatus.

FIG. 7 is a perspective view of a lens according to a preferred embodiment of the present invention as viewed from inside the rotary drive apparatus.

FIG. 8 is a perspective view illustrating an accommodating portion, which is able to accommodates a lens according to a preferred embodiment of the present invention, as viewed from below.

FIG. 9 is a perspective view of a lens of a rotary drive apparatus according to a first modification of a preferred embodiment of the present invention as viewed from inside the rotary drive apparatus.

FIG. 10 is a perspective view illustrating an accommodating portion, which is able to accommodate a lens, of the rotary drive apparatus according to the first modification of the above preferred embodiment of the present invention as viewed from below.

FIG. 11 is a perspective view of a lens of a rotary drive apparatus according to a second modification of a preferred embodiment of the present invention as viewed from inside the rotary drive apparatus.

FIG. 12 is a perspective view illustrating an accommodating portion, which is able to accommodate a lens, of the rotary drive apparatus according to the second modification of the above preferred embodiment of the present invention as viewed from below.

FIG. 13 is a perspective view of a lens according to a preferred embodiment of the present invention as viewed from outside a rotary drive apparatus according to a third modification of a preferred embodiment of the present invention.

FIG. 14 is a perspective view of a lens according to a preferred embodiment of the present invention as viewed from inside the rotary drive apparatus according to the third modification of the above preferred embodiment of the present invention.

### DETAILED DESCRIPTION OF THE PREFERRED EMBODIMENTS

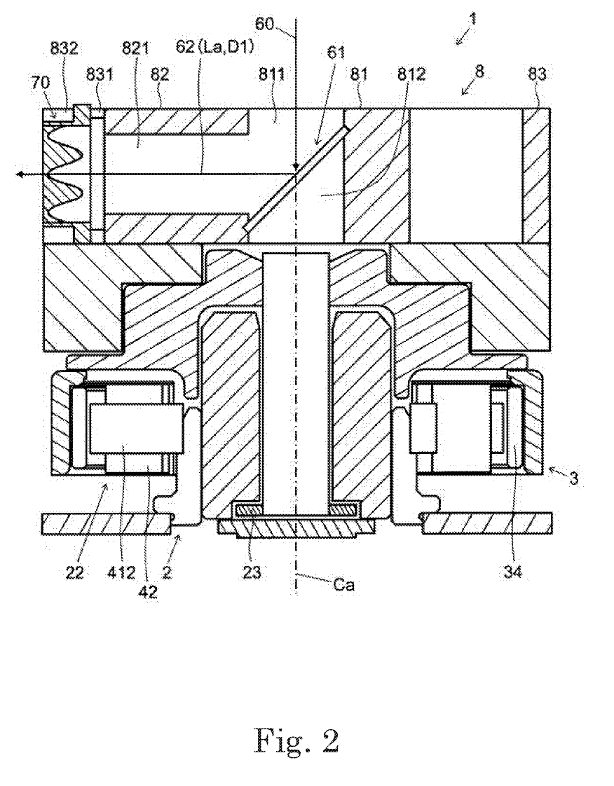

Hereinafter, preferred embodiments of the present invention will be described in detail with reference to the accompanying drawings. It is assumed herein that a direction in which a central axis of a motor of a rotary drive apparatus extends is referred to simply by the term “axial direction”, “axial”, or “axially”, that directions perpendicular to the central axis of the motor and centered on the central axis are each referred to simply by the term “radial direction”, “radial”, or “radially”, and that a direction along a circular arc centered on the central axis of the motor is referred to simply by the term “circumferential direction”, “circumferential”, or “circumferentially”. It is also assumed herein that an axial direction is a vertical direction for the sake of convenience in description, and the shape of each member or portion and relative positions of different members or portions will be described on the assumption that a vertical direction and upper and lower sides in FIG. 2 are a vertical direction and upper and lower sides of the rotary drive apparatus. It should be noted, however, that the above definition of the vertical direction and the upper and lower sides is not meant to restrict in any way the orientation of, or relative positions of different members or portions of, a rotary drive apparatus according to any preferred embodiment of the present invention when in use.

It is also assumed herein that, regarding a lens of a rotary drive apparatus, a direction in which an optical axis passing through the lens extends is referred to as an “optical axis direction”, and that directions perpendicular to the optical axis and centered on the optical axis are each referred to as a “lens radial direction”. The shape of each portion of the lens and relative positions of different portions of the lens will be described based on the above assumption. It is also assumed herein that a sectional view parallel to the axial direction is referred to as a “vertical sectional view”. Note that the wordings “parallel”, “at right angles”, “perpendicular”, etc., as used herein include not only “exactly parallel”, “exactly at right angles”, “exactly perpendicular”, etc., respectively, but also “substantially parallel”, “substantially at right angles”, “substantially perpendicular”, etc., respectively.

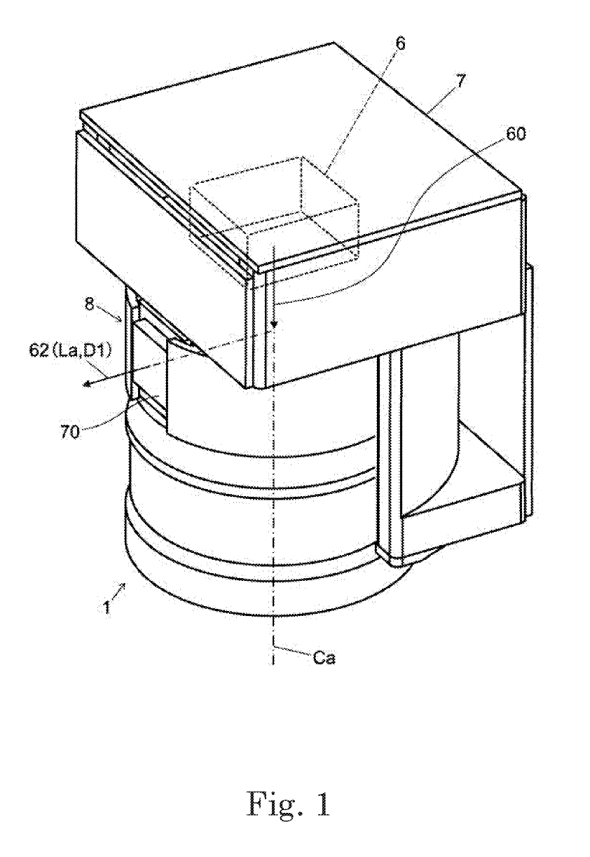

FIG. 1 is a perspective view of a light source 6, a frame 7, and a rotary drive apparatus 1 according to a preferred embodiment of the present invention. Referring to FIG. 1, the rotary drive apparatus 1 is an apparatus arranged to rotate a flywheel 8 that holds optical components each of which is arranged to reflect incoming light 60 coming from the light source 6 in a radial direction (i.e., a first radial direction D1) or allow the incoming light 6 to pass therethrough. The optical components include a lens 70 and a mirror 61 (see FIG. 2).

The frame 7 is arranged above the rotary drive apparatus 1. The frame 7 is fixed to a casing or the like in which the rotary drive apparatus 1 is arranged. The light source 6 is installed in the frame 7.

The light source 6 is arranged to emit the incoming light 60, which travels downward along a central axis Ca of a motor 10. In the present preferred embodiment, each of the light source 6 and the frame 7 is arranged outside of the rotary drive apparatus 1. Note, however, that each of the light source 6 and the frame 7 may alternatively be included in the rotary drive apparatus 1.

The rotary drive apparatus 1 includes the motor 10, the flywheel 8, and the optical components (i.e., the lens 70 and the mirror 61) held by the flywheel 8.

FIG. 2 is a vertical sectional view of the rotary drive apparatus 1 according to a preferred embodiment of the present invention. Referring to FIG. 2, the motor 10 includes a stationary portion 2 including a stator 22, and a rotating portion 3 including a magnet 34. The stationary portion 2 is arranged to be stationary relative to the casing or the like in which the rotary drive apparatus 1 is arranged. The rotating portion 3 is supported through a bearing portion 23 to be rotatable about the central axis Ca, which extends in the vertical direction, with respect to the stationary portion 2.

Once electric drive currents are supplied to coils 42 included in the stationary portion 2, magnetic flux is generated around each of a plurality of teeth 412, which are magnetic cores for the coils 42. Then, interaction between the magnetic flux of the teeth 412 and magnetic flux of the magnet 34 included in the rotating portion 3 produces a circumferential torque between the stationary portion 2 and the rotating portion 3. As a result, the rotating portion 3 is caused to rotate about the central axis Ca with respect to the stationary portion 2. Thus, the flywheel 8, which is rotatably supported by the rotating portion 3, is caused to rotate about the central axis Ca together with the rotating portion 3.

As the bearing portion 23, a fluid dynamic bearing, in which a portion of the stationary portion 2 and a portion of the rotating portion 3 are arranged opposite to each other with a gap in which a lubricating oil exists therebetween and which is arranged to induce a fluid dynamic pressure in the lubricating oil, is used, for example. Note that a bearing of another type, such as, for example, a rolling-element bearing, may alternatively be used as the bearing portion 23.

Referring to FIG. 2, the flywheel 8 is supported by an upper end portion of the rotating portion 3 of the motor 10, and is arranged to rotate about the central axis Ca together with the rotating portion 3. The flywheel 8 is fixed to an upper surface of the rotating portion 3 through, for example, an adhesive or the like.

The flywheel 8 holds each of the mirror 61 and the lens 70. A resin, for example, is used as a material of the flywheel 8. Glass, for example, is used as materials of the mirror 61 and the lens 70. The glass is not limited to particular types of glass. For example, organic glass, inorganic glass, a resin, or a metal may be used as the materials of the mirror 61 and the lens 70, but other materials may alternatively be used.

The mirror 61 is in the shape of a plate, and is arranged to have a rectangular or circular external shape. The mirror 61 is fixed to a resin member of the flywheel 8, and at least a portion of the mirror 61 is arranged on the central axis Ca. A reflecting surface of the mirror 61 is inclined at an angle of 45 degrees with respect to the axial direction and the first radial direction D1. A fully reflective mirror, for example, is used as the mirror 61. The incoming light 60 impinges on a central portion of the mirror 61. The central portion of the mirror 61 refers to the entire mirror 61, excluding a peripheral portion of the mirror 61. The incoming light 60 is reflected by the mirror 61 inside of the flywheel 8, and is changed in the direction of travel. Note that, instead of the mirror 61, a prism (not shown) or the like may alternatively be used to change the direction of travel of the incoming light 60.

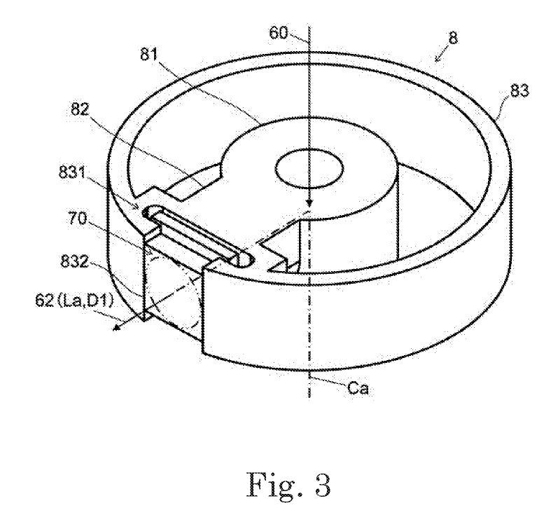

FIG. 3 is a perspective view of the flywheel 8 according to a preferred embodiment of the present invention. Referring to FIGS. 2 and 3, the flywheel 8 includes a vertical cylindrical portion 81, a horizontal cylindrical portion 82, and an outer cylindrical portion 83. In the present preferred embodiment, the vertical cylindrical portion 81, the horizontal cylindrical portion 82, and the outer cylindrical portion 83 are defined as a single monolithic member by a resin injection molding process. Note, however, that the vertical cylindrical portion 81, the horizontal cylindrical portion 82, and the outer cylindrical portion 83 may alternatively be defined by separate members.

The vertical cylindrical portion 81 is a cylindrical portion arranged to extend in the vertical direction along the axial direction in a radial center of the flywheel 8. The vertical cylindrical portion 81 has a cavity 811 defined radially inside thereof. The cavity 811 is arranged to extend in the vertical direction in parallel with the central axis Ca. The cavity 811 defines a light path.

The horizontal cylindrical portion 82 is a cylindrical portion arranged to extend radially outward in the radial direction (i.e., the first radial direction D1) from an outer circumferential portion of the vertical cylindrical portion 81. The horizontal cylindrical portion 82 has a cavity 821 defined inside thereof. The cavity 821 is arranged to extend in the radial direction perpendicularly to the central axis Ca. The cavity 821 is joined to the cavity 811 at right angles. The cavity 821 is arranged to overlap with each of the mirror 61 and the lens 70 when viewed in the first radial direction D1. The cavity 821 defines a light path.

The mirror 61 is fixed at a region at which the cavity 811 and the cavity 821 intersect with each other. In addition, the vertical cylindrical portion 81 has a cavity 812 below the region at which the mirror 61 is fixed. The cavity 812 is arranged to extend in the vertical direction in parallel with the central axis Ca. A portion of the incoming light 60 may alternatively be allowed to pass through the mirror 61 and then travel downward through the cavity 812.

The outer cylindrical portion 83 is a cylindrical portion arranged to extend in the vertical direction along the central axis Ca radially outside of the vertical cylindrical portion 81 and the horizontal cylindrical portion 82. An outer circumferential surface of the outer cylindrical portion 83 defines at least a portion of an outer circumferential surface of the flywheel 8. A radially outer end portion of the horizontal cylindrical portion 82 is joined to an inner circumferential surface of the outer cylindrical portion 83. Meanwhile, an outer circumferential surface of the vertical cylindrical portion 81 is joined to a radially inner end portion of the horizontal cylindrical portion 82. The outer cylindrical portion 83 has an accommodating portion 831 at a portion thereof to which the radially outer end portion of the horizontal cylindrical portion 82 is joined. The lens 70 is arranged in the accommodating portion 831. The structure of the accommodating portion 831 will be described in detail below.

The lens 70 is arranged to have an external shape being rectangular or circular when viewed in the optical axis direction passing through the lens 70. The lens 70 is accommodated in the accommodating portion 831, and is held by the flywheel 8, including the outer cylindrical portion 83. The lens 70 is arranged at right angles to the first radial direction D1 in the accommodating portion 831, and is arranged in parallel with the central axis Ca. An opening at a radially outer end portion of the cavity 821 of the horizontal cylindrical portion 82 is covered by the lens 70. The structure of the lens 70 will be described in detail below.

In the present preferred embodiment, the incoming light 60, which is emitted from the light source 6, enters the flywheel 8 from above an upper surface of the flywheel 8, and travels downward along the central axis Ca in the cavity 811 of the vertical cylindrical portion 81. The incoming light 60 is reflected by the mirror 61 inside of the vertical cylindrical portion 81 to become reflected light 62. The reflected light 62 travels outward in the first radial direction D1 in the cavity 821 of the horizontal cylindrical portion 82, and is emitted out of the rotary drive apparatus 1 through the lens 70.

The mirror 61 of the flywheel 8 is arranged to reflect the incoming light 60 coming from the light source 6 and emit the reflected light 62 to an outside of the rotary drive apparatus 1 while rotating about the central axis Ca together with the rotating portion 3 of the motor 10. Thus, a wide range can be irradiated with light. The rotation speed of the rotary drive apparatus 1 can be recognized by sensing the reflected light 62, which is emitted out of the flywheel 8, using an external sensor (not shown). Note that the outer circumferential surface of the flywheel 8 has a light reflectivity lower than that of a front surface of the mirror 61. This contributes to preventing diffuse reflection of the incoming light 60 coming from the light source 6.

Note that the rotary drive apparatus 1 may further include, in addition to the flywheel 8 arranged to emit the reflected light 62 to the outside in the first radial direction D1, another flywheel (not shown) which is arranged to emit reflected light to the outside in a second radial direction different from the first radial direction D1, and which is arranged, for example, below the motor 10. In this case, a half mirror the transmissivity and reflectivity of which are substantially equal is used as the mirror 61. Then, a half of the incoming light 60 which impinges on the mirror 61 in the flywheel 8 is caused to be reflected in the first radial direction D1 to be emitted to the outside. A remaining half of the incoming light 60 which impinges on the mirror 61 is allowed to pass through the mirror 61 and further travel downward through the cavity 812 of the vertical cylindrical portion 81. A through hole (not shown) passing through the motor 10 in the axial direction is defined around the central axis Ca in the motor 10. The portion of the incoming light 60 which has passed through the mirror 61 passes through the through hole and reaches the other flywheel arranged below the motor 10. Then, the portion of the incoming light 60 which has reached the other flywheel is caused to be reflected in the second radial direction to be emitted to the outside, using a fully reflective mirror (not shown) in the other flywheel. Note that a plurality of mirrors (not shown), including a half mirror, which are arranged to reflect the incoming light 60 in mutually different directions may alternatively be installed in the single flywheel 8 of the rotary drive apparatus 1.

When light is emitted out in the two different directions, i.e., the first radial direction D1 and the second radial direction, as described above, light beams that are emitted out in the two different directions take different times to reach an object to be irradiated with light while the motor 10 is running, and this makes it possible to precisely recognize the three-dimensional position of the object in a space. Note that the other flywheel may alternatively be arranged in a rotary drive apparatus (not shown) other than the rotary drive apparatus 1 including the flywheel 8.

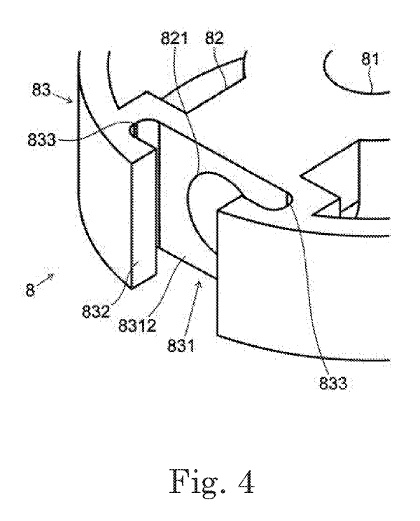

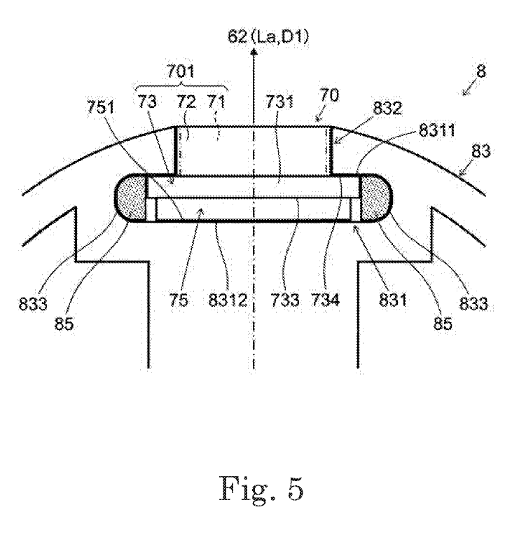

FIG. 4 is a perspective view illustrating the accommodating portion 831 for the lens 70 according to a preferred embodiment of the present invention. FIG. 5 is a top view illustrating the accommodating portion 831 for the lens 70 according to a preferred embodiment of the present invention. In FIG. 4, the lens 70 is not shown. Referring to FIGS. 4 and 5, the accommodating portion 831 is a cavity substantially in the shape of a rectangular parallelepiped, extending at right angles to the first radial direction D1, which is the direction of travel of the reflected light 62. An upper end portion of the accommodating portion 831 is exposed axially upwardly of the flywheel 8. A lower end portion of the accommodating portion 831 is exposed axially downwardly of the flywheel 8. The dimension of an interior of the accommodating portion 831 measured in the first radial direction D1 is greater than the thickness of the lens 70 measured in the first radial direction D1.

The accommodating portion 831 has an opening portion 832. The opening portion 832 is arranged at an edge portion of the accommodating portion 831 on an outer side in the first radial direction D1. The opening portion 832 is arranged to pass through the outer cylindrical portion 83 in the first radial direction D1 to open into the outside of the flywheel 8. An upper end portion of the opening portion 832 is exposed axially upwardly of the flywheel 8. A lower end portion of the opening portion 832 is exposed axially downwardly of the flywheel 8. The dimension of the opening portion 832 measured in a lateral direction (i.e., a circumferential direction), which is perpendicular to each of the first radial direction D1 and the axial direction, is smaller than the dimension of the accommodating portion 831 measured in the lateral direction (i.e., the circumferential direction), which is perpendicular to each of the first radial direction D1 and the axial direction.

In the accommodating portion 831, the lens 70 is arranged at right angles to the first radial direction D1. At this time, a portion of the lens 70 is arranged in the opening portion 832. The lens 70 is inserted into the accommodating portion 831 and the opening portion 832 along the axial direction from above or below the flywheel 8. The axial dimension of each of the accommodating portion 831 and the opening portion 832 is substantially equal to the axial dimension of the lens 70. The arrangement of the lens 70 in the accommodating portion 831 will be described in detail below.

In addition, the accommodating portion 831 further has pockets 833. Each pocket 833 is arranged adjacent to the lens 70 in the accommodating portion 831 in the lateral direction (i.e., the circumferential direction), which is perpendicular to each of the first radial direction D1 and the axial direction. The pocket 833 is a space extending in the vertical direction, i.e., in the axial direction. The pocket 833 is arranged to accommodate an adhesive 85 therein. The adhesive 85 is used to fix the lens 70 in the accommodating portion 831. That is, the lens 70 is supported by the accommodating portion 831.

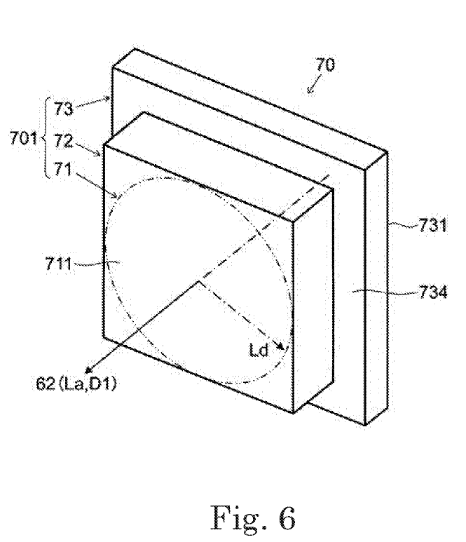

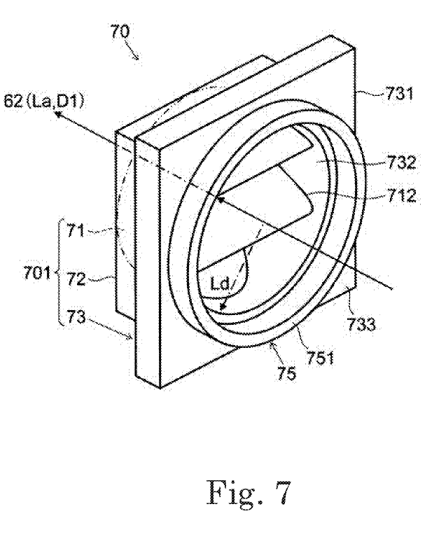

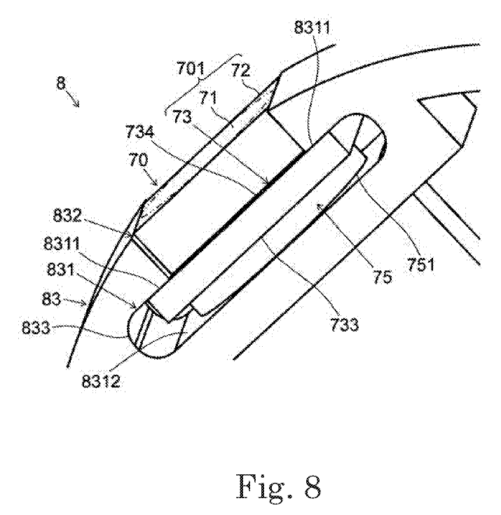

FIG. 6 is a perspective view of the lens 70 according to a preferred embodiment of the present invention as viewed from outside the rotary drive apparatus 1. FIG. 7 is a perspective view of the lens 70 according to a preferred embodiment of the present invention as viewed from inside the rotary drive apparatus 1. FIG. 8 is a perspective view illustrating the accommodating portion 831, which is arranged to accommodate the lens 70 according to a preferred embodiment of the present invention, as viewed from below. Referring to FIGS. 3 and 6, the lens 70 is arranged at right angles to an optical axis La passing through the lens 70. Note that the optical axis direction, in which the optical axis La passing through the lens 70 extends, coincides with the first radial direction D1. In the following description of the structure of the lens 70, the term “optical axis direction (D1)” is used as appropriate to describe the shapes of various portions of the lens 70 and relative positions of different portions of the lens 70.

The lens 70 includes a base portion 701. The base portion 701 includes a light-transmitting portion 71, a protective portion 72, and a collar portion 73. Note that the light-transmitting portion 71, the protective portion 72, and the collar portion 73 are defined by a single monolithic member.

The light-transmitting portion 71 is arranged to extend in lens radial directions Ld, which are perpendicular to the optical axis La, with the optical axis La as a center. The light-transmitting portion 71 is a portion arranged to allow the reflected light 62 to pass therethrough. The light-transmitting portion 71 is arranged to have an external shape being circular when viewed in the optical axis direction (D1), and is arranged to have a predetermined thickness in the optical axis direction (D1). The light-transmitting portion 71 includes an outer surface 711 on the side toward which the reflected light 62 is emitted (i.e., an outer side in the optical axis direction (D1)). The outer surface 711 is a flat surface extending in the lens radial directions Ld. The light-transmitting portion 71 has a curved and striped relief structure 712 on the side from which the reflected light 62 comes (i.e., an inner side in the optical axis direction (D1)).

The protective portion 72 is arranged outside of the light-transmitting portion 71 in the lens radial directions Ld. The protective portion 72 is a portion that does not allow the reflected light 62 to pass therethrough. The external shape of the protective portion 72 is in the shape of a rectangular parallelepiped, and the protective portion 72 is arranged to have a predetermined thickness in the optical axis direction (D1).

Referring to FIG. 5, a portion of the lens 70, including the protective portion 72, is arranged in the opening portion 832 when the lens 70 is arranged in the accommodating portion 831. The dimension of the protective portion 72 measured in the lateral direction (i.e., the circumferential direction), which is perpendicular to each of the optical axis direction (D1) and the axial direction, is substantially equal to the dimension of the opening portion 832 measured in the lateral direction (i.e., the circumferential direction), which is perpendicular to each of the optical axis direction (D1) and the axial direction. The thickness of the protective portion 72 measured in the optical axis direction (D1) is substantially equal to the thickness of a portion of the outer cylindrical portion 83 around the opening portion 832 measured in the optical axis direction (D1).

The collar portion 73 is arranged on the side (i.e., the inner side in the optical axis direction (D1)) of the protective portion 72 from which the reflected light 62 comes. The collar portion 73 is a portion that does not allow the reflected light 62 to pass therethrough. The external shape of the collar portion 73 is in the shape of a rectangular parallelepiped, and the collar portion 73 is arranged to have a predetermined thickness in the optical axis direction (D1). The collar portion 73 includes a projecting portion 731. The projecting portion 731 does not overlap with the protective portion 72 when viewed in the optical axis direction (D1) of the lens 70, and projects outward in the lens radial directions Ld relative to an outer edge portion of the protective portion 72.

The collar portion 73 has a through hole 732. The through hole 732 is arranged to overlap or coincide with the light-transmitting portion 71 when viewed in the optical axis direction (D1) of the lens 70, and is arranged to pass through the collar portion 73 in the optical axis direction (D1) of the lens 70. A portion of the relief structure 712, which is a portion of the light-transmitting portion 71, is accommodated in the through hole 732. This prevents a portion of the light-transmitting portion 71 from protruding radially inward from an inner surface 733 of the collar portion 73. The inner surface 733 lies on the side (i.e., the inner side in the optical axis direction (D1)) of the collar portion 73 from which the reflected light 62 comes. The light-transmitting portion 71 can thus be protected.

Referring to FIGS. 6 and 7, the lens 70 further includes a first contact portion 734 and a second contact portion 75.

The first contact portion 734 is an outer surface of the projecting portion 731 of the collar portion 73 which lies on the side toward which the reflected light 62 is emitted (i.e., the outer side in the optical axis direction (D1)). The first contact portion 734 is arranged on the downstream side of the collar portion 73 of the base portion 701 with respect to the direction of travel of the reflected light 62. The first contact portion 734 is a flat surface that lies on the opposite side to the inner surface 733 of the collar portion 73.

The second contact portion 75 is arranged on the side (i.e., the inner side in the optical axis direction (D1)) of the collar portion 73 from which the reflected light 62 comes. The second contact portion 75 is arranged on the upstream side of the collar portion 73 of the base portion 701 with respect to the direction of travel of the reflected light 62. The second contact portion 75 is a projection arranged to project from the collar portion 73.

The second contact portion 75 is in the shape of a circular ring, extending in the lens radial directions Ld with the optical axis La passing through the lens 70 as a center. The second contact portion 75 is arranged on the outer side of the through hole 732 with respect to the lens radial directions Ld. In other words, the inside diameter of the second contact portion 75 centered on the optical axis La is greater than the diameter of the through hole 732 centered on the optical axis La. An end portion of the second contact portion 75, which is the projection, includes a flat surface 751 extending perpendicularly to the optical axis La, and is arranged in an annular shape around the light-transmitting portion 71.

Referring to FIG. 5, the accommodating portion 831 has first contact surfaces 8311 and a second contact surface 8312. Each of the first contact surfaces 8311 and the second contact surface 8312 is a flat surface perpendicular to the first radial direction D1 and extending in the axial direction. Each first contact surface 8311 is arranged on the outer side of an interior space of the accommodating portion 831 in the first radial direction D1. The first contact surfaces 8311 are each arranged adjacent to the opening portion 832, and are arranged on the left and right sides of the opening portion 832 in FIG. 5. The second contact surface 8312 is arranged on the inner side of the interior space of the accommodating portion 831 in the first radial direction D1. The second contact surface 8312 is arranged adjacent to the opening at the radially outer end portion of the cavity 821 of the horizontal cylindrical portion 82, and is arranged to extend around this opening.

Referring to FIG. 8, when the lens 70 is arranged in the accommodating portion 831, the first contact portion 734 of the lens 70 is brought into contact with the first contact surfaces 8311 of the accommodating portion 831 on the downstream side of the collar portion 73 of the base portion 701 with respect to the direction of travel of the reflected light 62. In addition, the second contact portion 75 of the lens 70 is brought into contact with the second contact surface 8312 of the accommodating portion 831 on the upstream side of the collar portion 73 of the base portion 701 with respect to the direction of travel of the reflected light 62. The second contact portion 75 is the projection arranged to project from the collar portion 73. Thus, the lens 70 is positioned with respect to the optical axis direction (D1) in the accommodating portion 831.

With the above-described configuration, the base portion 701 is supported with a direct contact with the accommodating portion 831 on the downstream side with respect to the direction of travel of the reflected light 62, while the base portion 701 is in contact with the accommodating portion 831 through the projection on the upstream side with respect to the direction of travel of the reflected light 62. That is, the lens 70 is held while being in contact with the accommodating portion 831 at regions opposite to the lens 70 on both the upstream and downstream sides of the lens 70 with respect to the direction of travel of the reflected light 62. This leads to an improvement in the accuracy with which the lens 70 is temporarily fixed before the lens 70 is fixed through the adhesive 85.

In addition, the base portion 701 and the second contact portion 75, which is the projection, are defined by a single monolithic member. A reduction in a material cost can be achieved by the above two components of the lens 70 being defined by a single monolithic member.

In addition, the second contact portion 75, which is the projection, is arranged to be in contact with only the second contact surface 8312 of the accommodating portion 831 at the flat surface 751 in the shape of a circular ring. That is, the second contact portion 75 is not in contact with an entire region on the upstream side of the accommodating portion 831, including the second contact surface 8312, with respect to the direction of travel of the reflected light 62. Thus, the total area of contact of the lens 70 with the accommodating portion 831 can be minimized to achieve an improvement in the accuracy with which the lens 70 is temporarily fixed.

In addition, the lens 70 has only one second contact portion 75, which is a projection. This leads to an improvement in workability in inserting the lens 70 into the accommodating portion 831.

Further, the second contact portion 75, which is the projection, is arranged not to overlap with a light path passing through the light-transmitting portion 71. This prevents the projection from blocking the light path. This eliminates the need to take refraction of light into consideration, and thus leads to an improved productivity of the lens 70.

Furthermore, each pocket 833 of the accommodating portion 831 is arranged to accommodate the adhesive 85, which is used to fix the lens 70 in the accommodating portion 831. This leads to an increase in the strength with which the lens 70 is fixed to the flywheel 8 when compared to the case where the lens 70 is fixed to the flywheel 8 only through press fitting (with a small amount of force).

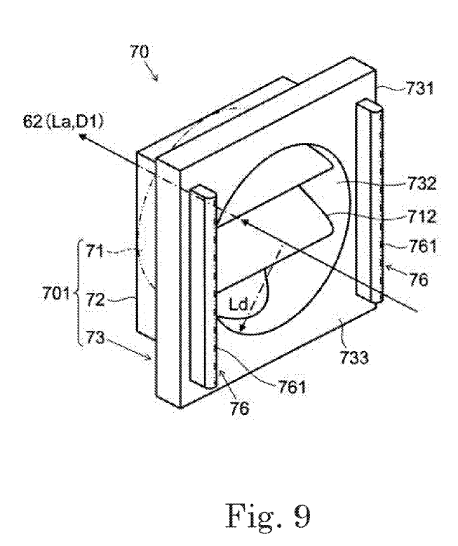

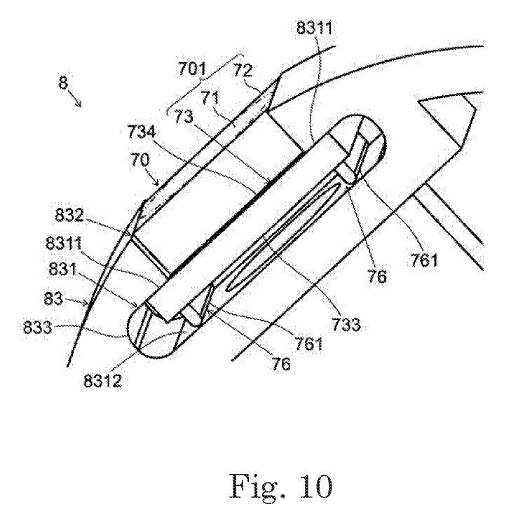

FIG. 9 is a perspective view of a lens 70 of a rotary drive apparatus 1 according to a first modification of the above-described preferred embodiment of the present invention as viewed from inside the rotary drive apparatus 1. FIG. 10 is a perspective view illustrating an accommodating portion 831, which is arranged to accommodate the lens 70, of the rotary drive apparatus 1 according to the first modification of the above-described preferred embodiment of the present invention as viewed from below. Referring to FIG. 9, the lens 70 includes second contact portions 76.

Each second contact portion 76 is arranged on the side (i.e., the inner side in the optical axis direction (D1)) of a collar portion 73 from which reflected light 62 comes. The second contact portion 76 is arranged on the upstream side of the collar portion 73 of a base portion 701 with respect to the direction of travel of the reflected light 62. The second contact portion 76 is a projection arranged to project from the collar portion 73. The lens 70 includes two second contact portions 76, each of which is a projection.

Each second contact portion 76 is in the shape of a rectangular parallelepiped, extending in a straight line in the vertical direction and perpendicularly to an optical axis La passing through the lens 70. The two second contact portions 76 are arranged to extend in parallel with a direction in which a central axis Ca extends on both sides of a light-transmitting portion 71 in the lateral direction (i.e., the circumferential direction), which is perpendicular to each of the direction of travel of the reflected light 62 and the axial direction. That is, each second contact portion 76 is arranged not to overlap with a light path passing through the light-transmitting portion 71. Note that the two second contact portions 76 may alternatively be arranged on upper and lower sides of a through hole 732. In addition, an utmost end of each second contact portion 76 is a straight line 761 extending in the vertical direction and perpendicularly to the optical axis La.

Referring to FIG. 10, according to this configuration, when the lens 70 is arranged in the accommodating portion 831, the two second contact portions 76 of the lens 70 are brought into contact with a second contact surface 8312 of the accommodating portion 831 on the upstream side of the collar portion 73 of the base portion 701 with respect to the direction of travel of the reflected light 62. In addition, the second contact portions 76 are arranged to be in contact with only the second contact surface 8312 of the accommodating portion 831 at the straight lines 761 at two separate positions. That is, the second contact portions 76 are not in contact with an entire region on the upstream side of the accommodating portion 831, including the second contact surface 8312, with respect to the direction of travel of the reflected light 62. Thus, the total area of contact of the lens 70 with the accommodating portion 831 can be minimized to achieve an improvement in the accuracy with which the lens 70 is temporarily fixed.

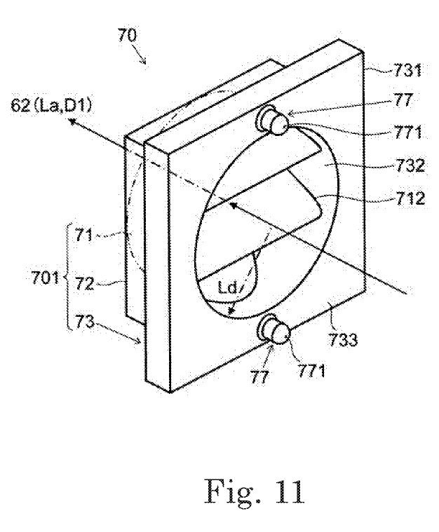

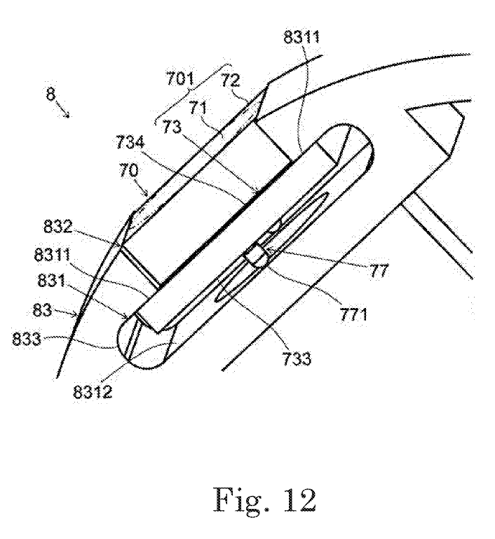

FIG. 11 is a perspective view of a lens 70 of a rotary drive apparatus 1 according to a second modification of the above-described preferred embodiment of the present invention as viewed from inside the rotary drive apparatus 1. FIG. 12 is a perspective view illustrating an accommodating portion 831, which is arranged to accommodate the lens 70, of the rotary drive apparatus 1 according to the second modification of the above-described preferred embodiment of the present invention as viewed from below. Referring to FIG. 11, the lens 70 includes second contact portions 77.

Each second contact portion 77 is arranged on the side (i.e., the inner side in the optical axis direction (D1)) of a collar portion 73 from which reflected light 62 comes. The second contact portion 77 is arranged on the upstream side of the collar portion 73 of a base portion 701 with respect to the direction of travel of the reflected light 62. The second contact portion 77 is a projection arranged to project from the collar portion 73. The lens 70 includes two second contact portions 77, each of which is a projection.

Each second contact portion 77 is columnar, extending in parallel with an optical axis La passing through the lens 70. The two second contact portions 77 are arranged on upper and lower sides of a through hole 732. That is, each second contact portion 77 is arranged not to overlap with a light path passing through a light-transmitting portion 71. Note that the two second contact portions 77 may alternatively be arranged on left and right sides of the through hole 732 in FIG. 11. An end portion of each second contact portion 77, which is a projection, is a hemispherical surface that projects to the upstream side with respect to the direction of travel of the reflected light 62, and which is circular in a section perpendicular to the optical axis La. In addition, an utmost end of each second contact portion 77 is a point 771.

Referring to FIG. 12, according to this configuration, when the lens 70 is arranged in the accommodating portion 831, the two second contact portions 77 of the lens 70 are brought into contact with a second contact surface 8312 of the accommodating portion 831 on the upstream side of the collar portion 73 of the base portion 701 with respect to the direction of travel of the reflected light 62. In addition, the second contact portions 77 are arranged to be in contact with only the second contact surface 8312 of the accommodating portion 831 at the points 771 at two separate positions. That is, the second contact portions 77 are not in contact with an entire region on the upstream side of the accommodating portion 831, including the second contact surface 8312, with respect to the direction of travel of the reflected light 62. Thus, the total area of contact of the lens 70 with the accommodating portion 831 can be minimized to achieve an improvement in the accuracy with which the lens 70 is temporarily fixed.

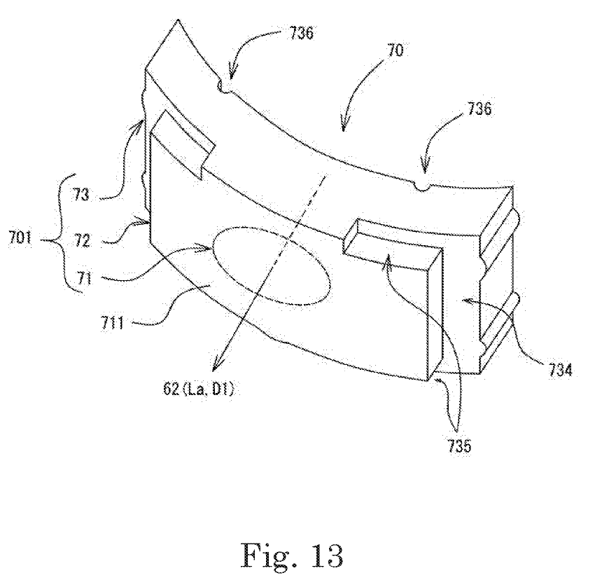

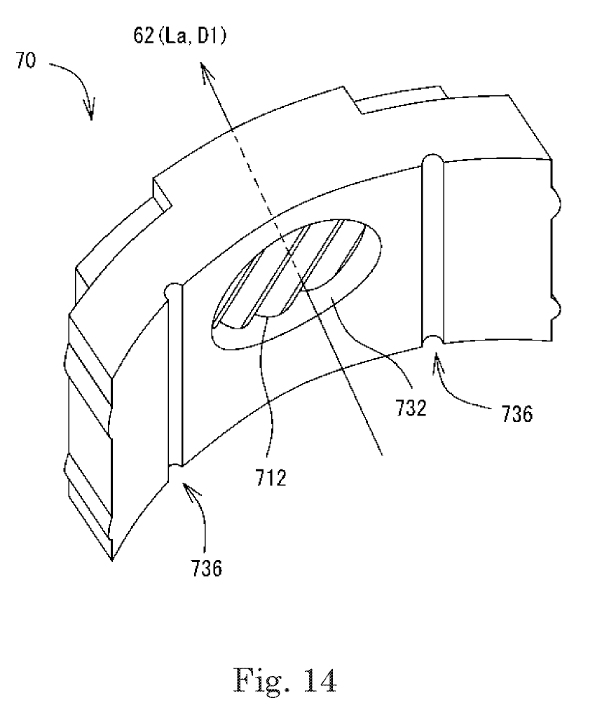

FIG. 13 is a perspective view of a lens 70 according to a preferred embodiment of the present invention as viewed from outside a rotary drive apparatus according to a third modification of the above-described preferred embodiment of the present invention. FIG. 14 is a perspective view of the lens 70 according to a preferred embodiment of the present invention as viewed from inside the rotary drive apparatus according to the third modification of the above-described preferred embodiment of the present invention.

Referring to FIG. 13, a collar portion 73 of the lens 70 includes first cuts 735 recessed from axially upper and lower portions of a first contact portion 734 toward a light-transmitting portion 71 (i.e., toward reflected light 62). In other words, a surface of the lens 70 which lies on the downstream side with respect to the direction of travel of the reflected light 62 includes cuts. The first cuts 735 are arranged on both sides of an optical axis La in the circumferential direction. In addition, referring to FIGS. 13 and 14, an inner surface 733 of the lens 70 includes second cuts 736 each of which is recessed radially outward. In other words, a surface of the lens 70 which lies on the upstream side with respect to the direction of travel of the reflected light 62 includes cuts. Each second cut 736 is arranged to extend in the axial direction from an axially upper surface to an axially lower surface of the lens 70. The second cuts 736 are arranged on both sides of the optical axis La in the circumferential direction. Further, at least a portion of each second cut 736 is arranged to coincide with at least a portion of at least one of the first cuts 735 when viewed in a radial direction.

Here, when the lens 70 and a flywheel 8 are fixed to each other by applying an adhesive 85 onto the first contact portion 734 and hardening the adhesive 85, the lens 70 and the flywheel 8 may become deformed by being pulled by the adhesive 85. Moreover, a deformation of the lens 70 and/or the flywheel 8 might cause the optical axis direction (D1) to be tilted.

With this configuration, the lens 70 has the first cuts 735 and the second cuts 736, and therefore, a pulling stress caused when the adhesive 85 hardens is applied to the first cuts 735 and the second cuts 736, and is not applied to the light-transmitting portion 71 or a portion of the flywheel 8 which is adjacent to the light-transmitting portion 71. This makes it possible to provide a high-precision product with a reduced possibility of tilting of the optical axis direction (D1).

While preferred embodiments of the present invention have been described above, it will be understood that the scope of the present invention is not limited to the above-described preferred embodiments, and that various modifications may be made to the above-described preferred embodiments without departing from the gist of the present invention. In addition, features of the above-described preferred embodiments and the modifications thereof may be combined appropriately as desired.

In the above-described preferred embodiment, the lens 70 is fixed in the accommodating portion 831 through the adhesive 85 injected into the pockets 833 of the accommodating portion 831. Note, however, that the lens 70 may not necessarily be fixed in the accommodating portion 831 by this method. For example, the lens 70 may alternatively be fixed in the accommodating portion 831 through press fitting. Further, the lens 70 may alternatively be fixed in the accommodating portion 831 through welding or screwing.

Preferred embodiments of the present invention are applicable to, for example, rotary drive apparatuses.

Features of the above-described preferred embodiments and the modifications thereof may be combined appropriately as long as no conflict arises.

While preferred embodiments of the present invention have been described above, it is to be understood that variations and modifications will be apparent to those skilled in the art without departing from the scope and spirit of the present invention. The scope of the present invention, therefore, is to be determined solely by the following claims.

What is claimed is:

1. A rotary drive apparatus that rotates a flywheel holding a mirror that reflects incoming light coming from a light source, and a lens that allows reflected light obtained by reflection of the incoming light to pass therethrough, the rotary drive apparatus comprising:
a motor; and
the flywheel; wherein
the flywheel is supported by the motor to rotate about a central axis extending in a vertical direction;
the flywheel includes an accommodating portion in which the lens is located;
the lens includes:
a base portion including a light-transmitting portion that allows the reflected light to pass therethrough;
a first contact portion contactable with the accommodating portion on one of an upstream side and a downstream side of the base portion with respect to a direction of travel of the reflected light; and
a second contact portion contactable with the accommodating portion on another one of the upstream side and the downstream side of the base portion with respect to the direction of travel of the reflected light; and
at least one of the first contact portion and the second contact portion is a projection that projects from the base portion.

2. The rotary drive apparatus according to claim 1, wherein the base portion and the projection are defined by a single monolithic member.

3. The rotary drive apparatus according to claim 1, wherein the projection is contactable with the accommodating portion at a point, a line, or a surface.

4. The rotary drive apparatus according to claim 1, wherein the projection does not overlap with a light path passing through the light-transmitting portion.

5. The rotary drive apparatus according to claim 4, wherein the projection has an annular shape around the light-transmitting portion.

6. The rotary drive apparatus according to claim 4, wherein two of the projections are located on both sides of the light-transmitting portion in a lateral direction perpendicular or substantially perpendicular to each of the direction of travel of the reflected light and an axial direction.

7. The rotary drive apparatus according to claim 4, wherein the projection extends parallel or substantially parallel to a direction in which the central axis extends.

8. The rotary drive apparatus according to claim 1, wherein
the accommodating portion includes a pocket outside of the lens; and
the pocket accommodates an adhesive used to fix the lens in the accommodating portion.

9. The rotary drive apparatus according to claim 1, wherein at least one of a surface of the lens on the upstream side with respect to the direction of travel of the reflected light and a surface of the lens which lies on the downstream side with respect to the direction of travel of the reflected light includes a cut between the first contact portion and the light-transmitting portion.

10. The rotary drive apparatus according to claim 1, wherein the lens includes cut portions recessed from axially upper and lower portions of the first contact portion toward the reflected light.

11. The rotary drive apparatus according to claim 1, wherein a surface of the lens on the upstream side with respect to the direction of travel of the reflected light includes a cut portion recessed radially outward.
